(19) United States
(12) Patent Application Publication
(10) Pub. No.: US 2026/0270932 A1
(43) Pub. Date: Sep. 10, 2026

(54) UE CONTEXT OF PASSIVE OBJECTS FOR MOBILITY

(71) Applicant: Telefonaktiebolaget LM Ericsson (publ), Stockholm (SE)

(72) Inventors: Ritesh Shreevastav, Upplands Väsby (SE); Julia Equi, Helsinki (FI); Gabor Fodor, Hässelby (SE)

(21) Appl. No.: 19/106,689

(22) PCT Filed: Aug. 31, 2023
(86) PCT No.: PCT/IB2023/058635

§ 371 Date: Feb. 26, 2025

Related U.S. Application Data
(60) Provisional application No. 63/403,526, filed on Sep. 2, 2022.

(51) Int. Cl. H04W 64/00; H04W 4/38; H04W 36/36

(52) U.S. Cl. CPC H04W 64/00; H04W 4/38; H04W 36/362

(57) ABSTRACT

Systems and methods are disclosed that relate to creation, storage, and transfer of contexts of passive objects detected in a wireless communication network. In one embodiment, a method performed by a first network node of a wireless communication network comprises detecting a passive object via sensing and creating a passive object context for the passive object, the passive object context comprising an identifier assigned to the passive object and information indicative of one or more attributes of the passive object. The method further comprises storing the passive object context for the passive object. In this manner, contexts of passive objects can be created and stored in the wireless communications network and can be used in the wireless network for various purposes.

### RELATED APPLICATIONS

This application claims the benefit of provisional patent application Ser. No. 63/403,526, filed Sep. 2, 2022, the disclosure of which is hereby incorporated herein by reference in its entirety.

### TECHNICAL FIELD

The present disclosure relates to a cellular communications system and, more specifically, to passive object detection in a cellular communications system.

### BACKGROUND

### Sensing

Recently, the system architectures (SA1 and SA2) groups of the 3^{rd} Generation Partnership Project (3GPP) have defined study items to identify use cases and architectural enhancements that will enable Joint Communications and Sensing (JCAS) in cellular networks [1]. Sensing using cellular networks can be performed in a monostatic setting when the transmitter and receiver sensing antennas are located in the same node and in a multi-static setting when the transmitter and receiver sensing antennas are located in different nodes.

In FIG. 1, different radar settings are depicted that can be deployed using cellular base stations. In FIG. 1(a), the monostatic setting refers to the setting for which the transmit sensing array antennas, denoted by TX-s, are co-located at the same node (here, the same base station) as the receiver sensing antenna array, denoted by RX-s. In FIG. 1(b), the bi-static setting corresponds to the case where the transmit sensing array antennas TX-s are located at a different node compared to the receiver sensing antennas RX-s. Finally, in FIG. 1(c), the multi-static case is presented for which several TX-s and several RX-s are present and they are all located at different nodes (base stations in the example of FIG. 1).

Monostatic radar case for which the base station uses 5^{th} Generation (5G) millimeter wave (mmWave) signals for sensing was considered in Barneto et al. [2], [3] where estimation of range and velocity resolutions and self-interference analysis are performed. Target localization using bistatic and multistatic radar with 5G New Radio (NR) waveform was studied in [4] using 5G based on measurements of time difference of arrival and angle of arrival with 5G NR waveforms.

### Positioning

The NR Positioning architecture is illustrated in FIG. 2. The Location Management Function (LMF) is the location node in NR. There are also interactions between the location node and the gNodeB (gNB) via the NR Positioning Protocol A (NRPPa) protocol. The interactions between the gNB and the device (e.g., User Equipment or UE) is supported via the Radio Resource Control (RRC) protocol.

NR supports the following Radio Access Technology (RAT) dependent positioning methods:
DL-TDOA: The downlink (DL) Time Difference of Arrival (TDOA) positioning method makes use of the DL Reference Signal Time Difference (RSTD) (and optionally DL Positioning Reference Signal (PRS) Reference Signal Received Power (RSRP)) of downlink signals received from multiple Transmission Points (TPs), at the UE. The UE measures the DL RSTD (and optionally DL PRS RSRP) of the received signals using assistance data received from the positioning server, and the resulting measurements are used along with other configuration information to locate the UE in relation to the neighboring TPs.
Multi-RTT: The Multi-Round Trip Time (RTT) positioning method makes use of the UE Receive to Transmit (Rx-Tx) measurements and DL PRS RSRP of downlink signals received from multiple TRPs, measured by the UE and the measured gNB Rx-Tx measurements and uplink (UL) Sounding Reference Signal (SRS) RSRP at multiple Transmission and Reception Points (TRPs) of uplink signals transmitted from UE.
UL-TDOA: The UL TDOA positioning method makes use of the UL TDOA (and optionally UL SRS-RSRP) at multiple Receive Points (RPs) of uplink signals transmitted from UE. The RPs measure the UL TDOA (and optionally UL SRS-RSRP) of the received signals using assistance data received from the positioning server, and the resulting measurements are used along with other configuration information to estimate the location of the UE.
DL-AoD: The DL Angle of Departure (AoD) positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.
UL-AoA: The UL Angle of Arrival (AoA) positioning method makes use of the measured azimuth and zenith of arrival at multiple RPs of uplink signals transmitted from the UE. The RPs measure Azimuth AoA (A-AoA) and Zenity AoA (Z-AoA) of the received signals using assistance data received from the positioning server, and the resulting measurements are used along with other configuration information to estimate the location of the UE.

NR-ECID: NR Enhanced Cell Identity (ID) (NR E-CID) positioning refers to techniques which use additional UE measurements and/or NR radio resource and other measurements to improve the UE location estimate.

### Passive Object

A passive object is an object which does not have any means to get connectivity. In most of the cases, the passive object is moving (e.g., cars without Subscriber Identity Module (SIM) card, a person without mobile phone, animals, vulnerable road users without a UE, etc.).

The passive object can be not moving at a given time, but it can change its position over some period of time (e.g., person not moving, sleeping animal, etc.). A passive object should be differentiated from other objects in the environments such as walls, buildings, or other static objects belonging to the environment.

In general, a passive object is any object whose presence/position has to be known by the network in a given use case or scenario, but the passive object cannot communicate with the network through the communication link.

### SUMMARY

Systems and methods are disclosed that relate to creation, storage, and transfer of contexts of passive objects detected in a wireless communication network. In one embodiment, a method performed by a first network node of a wireless communication network comprises detecting a passive object via sensing and creating a passive object context for the passive object, the passive object context comprising an identifier assigned to the passive object and information indicative of one or more attributes of the passive object. The method further comprises storing the passive object context for the passive object. In this manner, contexts of passive objects can be created and stored in the wireless communications network and can be used in the wireless network for various purposes.

In one embodiment, the network node is a Radio Access Network (RAN) node of a cellular communications system.

In one embodiment, the network node is a core network node of a cellular communications system.

In one embodiment, the identifier assigned to the passive object comprises a combination of a first identifier and a second identifier. The first identifier is an identifier of any one or more of the following: the first network node, a cell operated by the first network node in which the passive object is located, and a beam provide by the first network node in which the passive object is located. The second identifier is an identifier for the passive object. In one embodiment, the second identifier is specific to the passive object. In one embodiment, the second identifier is based on a geographic location of the passive object. In one embodiment, the second identifier is based on a combination of a velocity of the passive object and a geographic location of the passive object. In one embodiment, the geographic location of the passive object is a grid location of the passive device within a predefined geographic grid.

In one embodiment, the identifier assigned to the passive object is: specific to the passive object, based on a geographic location of the passive object, or based on a combination of a velocity of the passive object and a geographic location of the passive object.

In one embodiment, the identifier assigned to the passive object comprises: a first set of bits indicative of the network node, a cell operated by the network node, or a beam served by the first network node; a second set of bits indicative of a location of the passive object; and a third set of bits indicative of the passive object.

In one embodiment, the one or more attributes of the passive object indicated by the information comprised in the passive object context comprise:
(a) a current cell operated by the first network node in which the passive object is located;
(b) a current beam provided by the first network node in which the passive object is located;
(c) a round trip time of a reflected signal from the passive object;
(d) a Doppler frequency of a reflected signal from the passive object;
(e) a velocity of the passive object;
(f) a speed of the passive object;
(g) a direction of movement of the passive object;
(h) an angle of movement of the passive object relative to the first network node;
(i) a shape of the passive object;
(j) a location of the passive object;
(k) passive object type;
(l) probability of the passive object moving to a geographic area or cell served by a neighboring network node;
(m) priority; or
(n) a combination of any two or more of (a)-(m).

In one embodiment, the passive object context further comprises a timestamp.

In one embodiment, the method further comprises detecting a trigger condition for handover of the passive object context to one or more neighboring network nodes and, responsive to detecting the trigger condition for handover of the passive object context, sending the passive object context of the passive object to at least one of the one or more neighboring network nodes. In one embodiment, the trigger condition for handover of the passive object context to one or more neighboring network nodes is based on any one or more of the following: a location of the passive object, a direction of movement of the passive object, and a speed of movement of the passive object. In one embodiment, detecting the triggering condition for handover of the passive object context to the one or more neighboring nodes comprises determining a probability of the passive object moving to a geographic area or cell served by a neighboring network node. In one embodiment, the triggering condition is a condition where the determined probability is greater than a threshold probability.

Corresponding embodiments of a first network node for a wireless communication network are disclosed. In one embodiment, a first network node for a wireless communication network is adapted to detect a passive object via sensing and create a passive object context for the passive object, the passive object context comprising an identifier assigned to the passive object and information indicative of one or more attributes of the passive object. The first network node is further adapted to store the passive object context for the passive object.

In one embodiment, a first network node for a wireless communication network comprises a communication interface and processing circuitry associated with the communication interface. The processing circuitry is configured to cause the first network node to detect a passive object via sensing and create a passive object context for the passive object, the passive object context comprising an identifier assigned to the passive object and information indicative of one or more attributes of the passive object. The processing circuity is further configured to store the passive object context for the passive object.

Embodiments of a method performed by a second network node for a wireless communication network are also disclosed. In one embodiment, a method performed by a second network node for a wireless communication network comprises receiving, from a first network node, a passive object context for a passive object, the passive object context comprising an identifier assigned to the passive object and information indicative of one or more attributes of the passive object, and enabling a sensing beam in a direction of the passive object.

In one embodiment, the first network node is a RAN node of a cellular communications system or a first core network node of the cellular communications system. In one embodiment, the second network node is a RAN node of the cellular communications system.

In one embodiment, the direction of the passive object is determined based on information comprised in the passive object context or information received from the first network node.

In one embodiment, the method further comprises monitoring the passive object based on the sensing beam and updating the passive object context of the passive object based on one or more results of the monitoring.

In one embodiment, the method further comprises determining that the passive object has not been detected, based on the sensing beam, for a certain amount of time and, responsive thereto, disabling the sensing beam. In one embodiment, the certain amount of time is predefined, configured, or determined by the second network node.

In one embodiment, the identifier assigned to the passive object comprises a combination of a first identifier and a second identifier. The first identifier is an identifier of any one or more of the following: the first network node, a cell operated by the first network node in which the passive object is located, and a beam provide by the first network node in which the passive object is located. The second identifier is an identifier for the passive object. In one embodiment, the second identifier is specific to the passive object. In one embodiment, the second identifier is based on a geographic location of the passive object. In one embodiment, the second identifier is based on a combination of a velocity of the passive object and a geographic location of the passive object. In one embodiment, the geographic location of the passive object is a grid location of the passive device within a predefined geographic grid.

In one embodiment, the identifier assigned to the passive object is: specific to the passive object, based on a geographic location of the passive object, or based on a combination of a velocity of the passive object and a geographic location of the passive object.

In one embodiment, the identifier assigned to the passive object comprises: a first set of bits indicative of the first network node, a cell operated by the first network node, or a beam served by the first network node; a second set of bits indicative of a location of the passive object; and a third set of bits indicative of the passive object.

In one embodiment, the one or more attributes of the passive object indicated by the information comprised in the passive object context comprise:
(a) a current cell operated by the first network node in which the passive object is located;
(b) a current beam provided by the first network node in which the passive object is located;
(c) a round trip time of a reflected signal from the passive object;
(d) a Doppler frequency of a reflected signal from the passive object;
(e) a velocity of the passive object;
(f) a speed of the passive object;
(g) a direction of movement of the passive object;
(h) an angle of movement of the passive object relative to the first network node;
(i) a shape of the passive object;
(j) a location of the passive object;
(k) passive object type;
(l) probability of the passive object moving to a geographic area or cell served by a neighboring network node;
(m) priority; or
(n) a combination of any two or more of (a)-(m).

In one embodiment, the passive object context further comprises a timestamp.

Corresponding embodiments of a second network node for a wireless communication network are also disclosed. In one embodiment, a second network node for a wireless communication network is adapted to receive, from a first network node, a passive object context for a passive object, the passive object context comprising an identifier assigned to the passive object and information indicative of one or more attributes of the passive object, and enable a sensing beam in a direction of the passive object.

In one embodiment, a second network node for a wireless communication network comprises a communication interface and processing circuitry associated with the communication interface. The processing circuitry is configured to cause the second network node to receive, from a first network node, a passive object context for a passive object, the passive object context comprising an identifier assigned to the passive object and information indicative of one or more attributes of the passive object, and enable a sensing beam in a direction of the passive object.

Embodiments of a method performed by a RAN node are also disclosed. In one embodiment, a method performed by a RAN node comprises detecting a passive object via sensing, sending, to a central entity, information about the passive object, and receiving, from the central entity, an identifier assigned to the passive object.

Corresponding embodiments of a RAN node are also disclosed. In one embodiment, a RAN node is adapted to detect a passive object via sensing, send, to a central entity, information about the passive object, and receive, from the central entity, an identifier assigned to the passive object.

In one embodiment, a RAN node comprises a communication interface and processing circuitry associated with the communication interface. The processing circuitry is configured to cause the RAN node to detect a passive object via sensing, send, to a central entity, information about the passive object, and receive, from the central entity, an identifier assigned to the passive object.

In another embodiment, a method performed by a RAN node comprises receiving, from a central entity, an identifier assigned to a passive object and storing the identifier assigned to the passive object.

In one embodiment, receiving the identifier comprises receiving the identifier assigned to the passive object in association with a mobility event in which the passive object moves into or moves towards a geographic area served by the RAN node.

Corresponding embodiments of a RAN node are also disclosed. In one embodiment, a RAN node is adapted to receive, from a central entity, an identifier assigned to a passive object and store the identifier assigned to the passive object.

In one embodiment, a RAN node comprises a communication interface and processing circuitry associated with the communication interface. The processing circuitry is configured to cause the RAN node to receive, from a central entity, an identifier assigned to a passive object and store the identifier assigned to the passive object.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates different radar settings that can be deployed using cellular base stations;

FIG. 2 illustrates the New Radio (NR) positioning architecture;

FIG. 3 illustrates an example of area Identifiers (IDs) assigned to passive objects, in accordance with an embodiment of the present disclosure;

FIG. 4 illustrates an example of velocity Identifiers (IDs) that can be assigned to passive objects based on their velocities, in accordance with an embodiment of the present disclosure;

FIG. 5 illustrates an example of combined area and velocity Identifiers (IDs) assigned to passive objects, in accordance with an embodiment of the present disclosure;

FIGS. 6, 7, and 8 illustrate example embodiments of a procedure for creating, storing, and transferring a passive object context;

FIG. 9 illustrates another embodiment of the present disclosure in which passive object IDs are created by central entity;

FIG. 10 shows an example of a communication system in accordance with some embodiments;

FIG. 11 shows a User Equipment (UE) in accordance with some embodiments; and

FIG. 12 shows a network node in accordance with some embodiments.

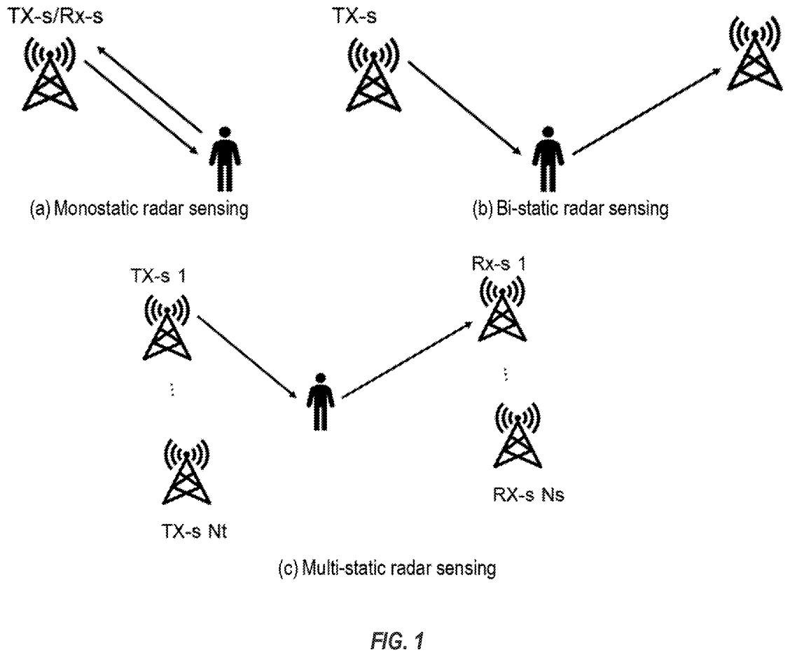

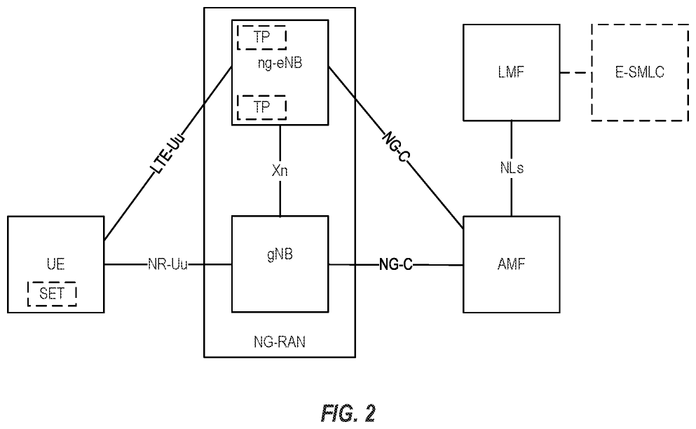

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s). Sensing needs to be performed for passive objects to identify or assess the environment, identify or detect clutters, or the like. For road safety cases, it is necessary to identify any vulnerable road user (even without cellular connectivity) and alert the driver or the control entity (in the case of autonomous driving).

Once the passive object has been identified, how to store its User Equipment (UE) context and how to pass this UE context as part of the handover procedure are a challenge, since currently no mechanism exists to define a UE context for a non-connected object. At the same time, it is desirable to track a passive object as it moves from the coverage area of a network node to the coverage area of another network node.

A connected UE in a cell has a Radio Network Temporary Identifier (RNTI), which is used to differentiate or identify the UE or a group of UEs in the cell. Each RNTI has a specific value defined by specifications, depending on the use case, and it may have different values for different UEs or a common value (for example in a broadcast) to all UEs in the cell.

The main problem with passive object identification is that it is not able to send or receive an identifier using the prior art mechanisms defined for connected UEs. Hence, some of the above parameters (e.g., RNTIs) and associated context management procedures are not useful to identify a passive object.

Further, projecting sensing beams is expensive in terms of resources and sensing is also computationally complex.

How identification and detection should be done for an object that moves across the coverage area of several base stations (network nodes) and how the sensing beam activation from a base station at the right time towards the passive object is performed are challenges in the state-of-the-art systems.

Certain aspects of the disclosure and their embodiments may provide solutions to these or other challenges. In the present disclosure, embodiments of systems and methods that define and manage a UE context for passive objects is provided. It is also showed how to use/pass these UE contexts during handover. Such UE contexts may also be referred to herein as “passive object UE contexts” or “passive object contexts” or “contexts of passive objects” or the like.

In one embodiment, a passive object UE context comprises (or consists of) of an identifier (e.g., a UE Identifier (ID) including or consisting of, e.g., a passive UE ID+gNB ID) and one or more attributes. In one embodiment, the one or more attributes comprise one or more of the following sensing output results:
Current Cell ID and/or Beam ID in which the passive object is located,
Area ID of a geographic area in which the passive object is located,
Round trip time of a reflected signal (time when signal was sent by a sender (e.g., a base station)+time when the reflected signal was received by the sender (e.g., the same base station)),
Doppler frequency (e.g., Doppler frequency associated to the passive object, e.g., as sensed by a reflected from the passive object received at, e.g., a base station),
Velocity (e.g., velocity of the passive object),
Angle of arrival (e.g., angle of arrival of the moving passive object relative to, e.g., a base station),
angle of departure (e.g., angle of departure of the moving passive object relative to, e.g., a base station),
Shape (e.g., shape of the passive object).

Embodiments of the present disclosure also define a triggering criterion for moving the UE context of a passive object to a neighboring base station. The UE context and the triggering criterion together address the problems with existing technology.

In one embodiment, a procedure is provided whereby it is made possible for a network (NW) node (e.g., a node or entity) performing sensing to define the passive object with an identifier and associated attribute(s). According to one embodiment, the NW node is able to handover the UE context (e.g., identifier and attributes) to a neighbor network node (e.g., gNB), such that the other network node (gNB) is able to uniquely identify the passive object and project a beam towards the passive object.

Certain embodiments may provide one or more of the following technical advantage(s):
Define Passive Object UE context,
As Sensing could require full duplex operation, consumes large resources (dedicated beams for sensing), and is computational heavy, the sensing beams can be invoked on-demand, i.e., only when it is essential to save NW power and resources,
According to some embodiments, a NW node obtains a-priori knowledge of a passive object and its associated attributes. A-priori knowledge of a passive object helps the NW node to detect and track the object faster and using less energy than without a-priori knowledge.
Identifying the right beams (angle of departure; correct antenna elements, precoders) beforehand can save resources and allow efficient sensing.

A non-connected, or passive, object can be identified by some specific parameters, which can be different from those needed by a connected UE. For example, position information, velocity, and direction information can be included to assign an identifier to a passive object.

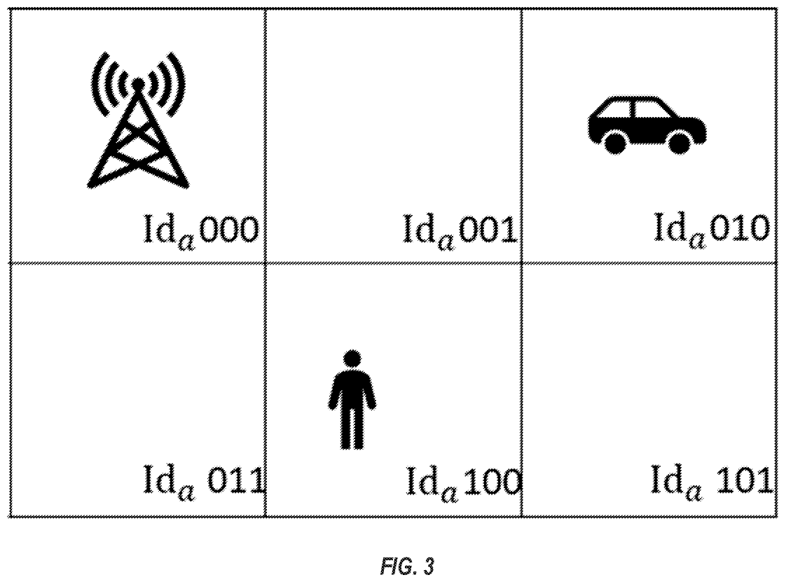

Indeed, sensing of a passive objective is usually area dependent. There is typically a need to sense objects in a specific area, as depicted in FIG. 3. The size and the shape of the grid in the sensing area should be adjusted, depending on the scenario, available resources, desired sensing granularity, etc. As illustrated in FIG. 3, each area in the grid is assigned a different area ID, denoted in FIG. 3 as Idₐ, and passive objects detected in these areas are assigned the corresponding Idₐ.

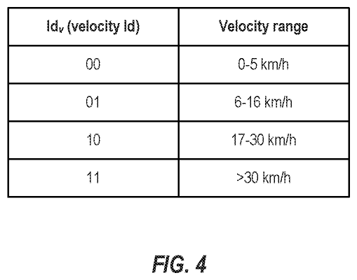

Depending on the size of the specific area associated to each identifier, several objects may be detected in the same area, and velocity and/or direction information can be used to further differentiate different passive objects. An example of a velocity ID table is provided in FIG. 4, where the velocity ID depends on a given range of velocities. The ranges can be defined depending on the scenario or use case.

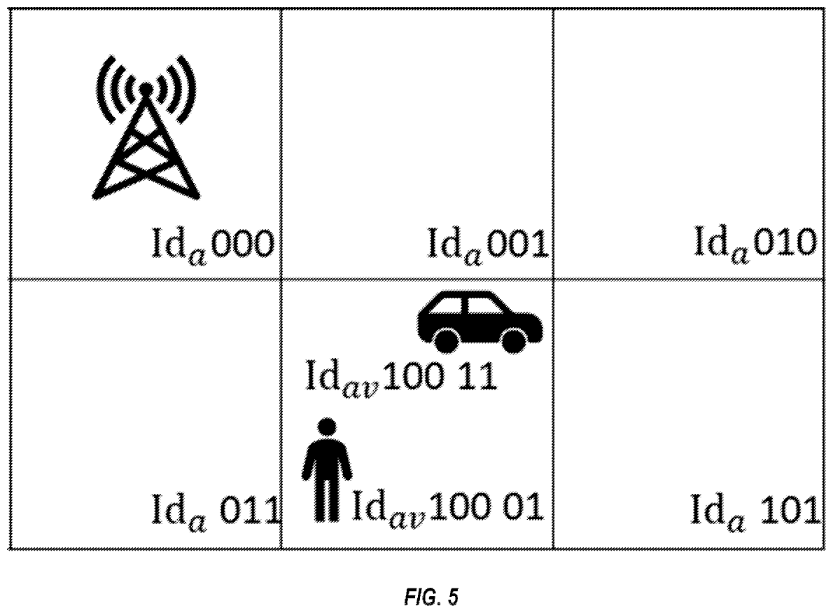

In FIG. 5, the identifier is based on a combination of two IDs: the area ID, denoted by Idₐ (where the index “a” stands for “area”), and the passive object's detected velocity ID, denoted by Idᵥ (where the index “v” stands for “velocity”) with an example of a table giving different velocity ranges with the corresponding Idᵥ. Similarly, to the area-based ID, the granularity of the velocity ranges for defining the velocity-based ID can be adjusted. The resulting identifier based on the combination of Idₐ and Idᵥ is denoted in FIG. 5 as Idₐᵥ.

Other possible identifier parameters can include the object's direction (e.g., relative to the base station), angle of arrival/departure (e.g., relative to the base station), etc.

In one embodiment, in order to identify the passive object, each base station (e.g., gNB) records the following:
gNB ID and cell ID, beam ID, and/or areaID, where the object was detected
Time Stamp

Further, any one or more of the following attributes related to the passive object may also be recorded:
Velocity
Round trip time
Angle of Departure
Angle of Arrival
Doppler Frequency
Shape (square, round, rectangle, length, width, height)
Passive object detection (animal, human, car, obstacles)
Probability of the object reaching to neighbor base station
Priority association (for e.g., whether it is hazard or non-hazard for traffic)
Group of objects or single object
   As such, these attributes can be categorized as object internal attributes (e.g., velocity, shape, type of passive object detected (e.g., animal, human, car, obstacle), or whether the passive object is a single object or group of objects) and object external attributes (e.g., round trip time, angle of departure, angle of arrival, Doppler frequency, probability of the object reaching to a neighbor base station, priority association,).

According to one embodiment, each base station is pre-assigned a pool of identifiers which is unique to each base station, and the base station uses such an identifier to associate it with the passive object.

The identifier can have the most significant bits fixed with an ID of the base station (e.g., gNB ID) and/or the area ID and the remaining bits are reserved for the object ID:

UE ID->gNB ID bits+Area ID bits+Object ID Bits

The assigned UE ID can be valid for single object or group of objects (e.g., herd of animals, platoon vehicles) which are moving in same/similar direction, trajectory, and speed.

The gNB may use some of the detected attributes to determine whether a handover of the passive object is likely to happen. For example, if the position of the passive object is within a certain range of a neighbor base station and the velocity vector points toward the cell area associated with that neighbor base station, the current base station triggers a sensing context handover procedure.

As part of a handover, the above association with the attributes is provided to the neighbor, or target, base station (or multiple neighbor base stations if there are multiple base stations in the direction in which the passive object is moving) so that the other gNB(s) is/are aware of any passive object approaching towards it and takes necessary action, such as, e.g., projecting a beam in the direction of the passive object.

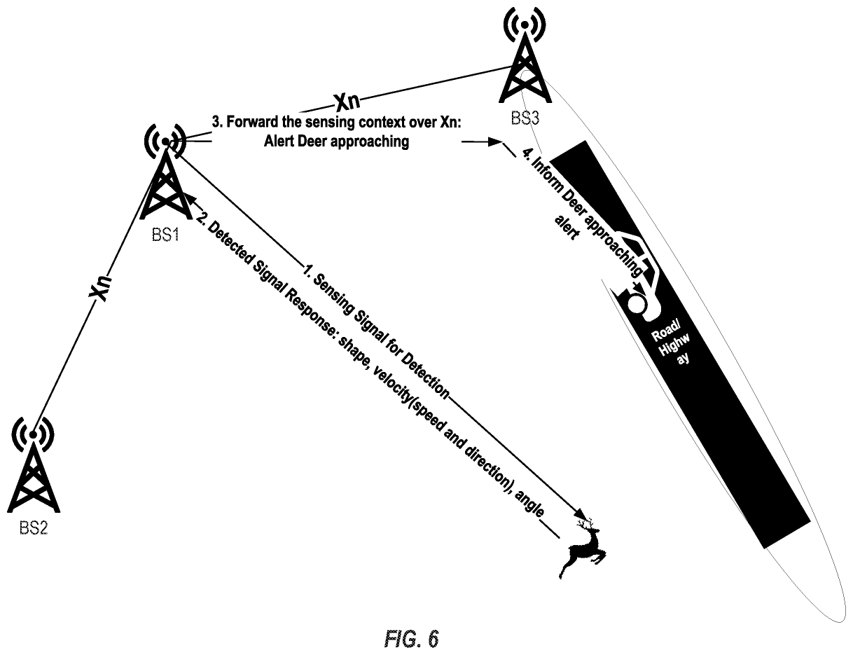

An example is shown in FIG. 6.

By way of the example of the triggering condition and handover procedure illustrated in FIG. 6, the following steps may be executed:
Steps 1 and 2: A base station 1 (BS1) detects the passive object (deer in the illustrated example) with its sensing beam. More specifically, in this example, BS1 transmits a sensing signal (e.g., a transmit (tx) beam in the direction of the passive object) and detects a reflected signal that is indicative of one or more attributes of the passive object such as, e.g., shape of the passive object, velocity of the passive object, angle of arrival/departure of the passive object relative to BS1, and/or the like. BS1 gives the passive object an identifier, which in this example is:
   UE ID->BS1+Beam ID1+Object ID1->001001001, where in the example, the first three bits (001) correspond to BS1, the next three bits (001) correspond to Beam ID1, and the last three bits (001) correspond to the Object ID.
      The identifier along with the other characteristics of the passive object such as velocity, angular information, etc. is recorded along with a timestamp (i.e., as the passive object context). The timestamp can be UTC timestamp or associated sensing beam Tx transmission such as system frame number, sub frame number, slot number, symbol number.
Step 3: BS1 computes the probability of the object moving and reaching to another BS (e.g., BS2 or BS3). For this purpose, it uses the criteria discussed above. It alerts the other BS(s) providing the probability by which the passive object would arrive to the other BS(s) as part of passive object Handover (e.g., using Xn interface). The passive object context is provided to BS3 in the illustrated example.
Step 4: BS3 informs another device (e.g., a UE of a person or a UE-equipped automobile) of the approaching passive object.

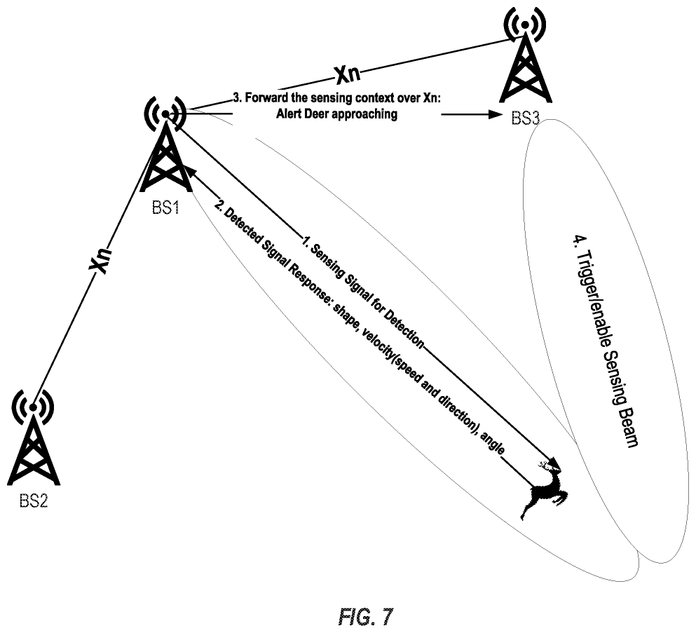

FIG. 7 illustrates another alternative in which, in step 4, the other BS (BS3 in this example) initiates a beam transmission towards the passive object based upon the input received from the BS1. Note that, in one embodiment, BS1 may perform both step 4 of FIG. 6 and step 4 of FIG. 7. As noted, steps 1-3 in FIG. 7 are the same as those of FIG. 6.

It is also possible to have a sensing management function which obtains the results from BS1 and alerts BS3. In such a case, rather than using the Xn interface, another interface would be used.

In one embodiment, the probability is encoded as (0 . . . 100) where for example 70 would imply 70% chance of reaching to the target BS. A BS may be configured to project a sensing beam only when the probability is above a certain threshold.

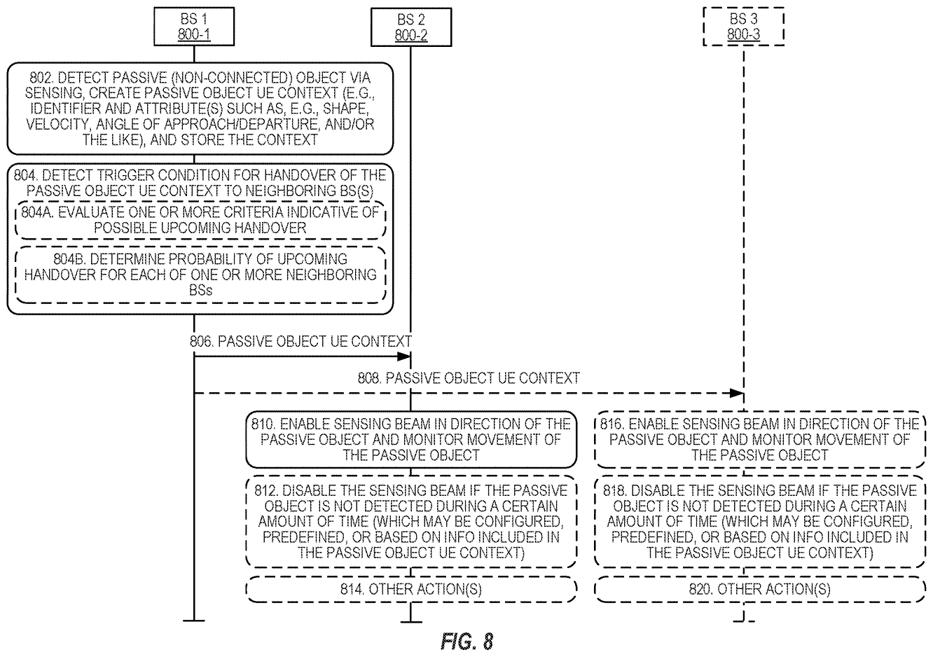

FIG. 8 illustrates the operation of a first base station (BS1) 800-1, a second base station (BS2) 800-2, and optionally a third base station (BS3) 800-3 in accordance with embodiments of the present disclosure. Note that while base stations 800-1, 800-2, and 800-3 are used for this example, the base stations 800-1, 800-2, and 800-3 may be any type of radio access network (RAN) node (e.g., a RAN node that performs part of the functionality of a base station such as, e.g., a Distributed Unit (DU) of a gNB or a Central Unit (CU) of a gNB having a split architecture). Also note that optional steps/features of FIG. 8 are represented by dashed lines/boxes. As illustrated, the steps of the process of FIG. 8 are as follows:
Step 802: The first base station 800-1 detects a passive, or non-connected, object via sensing (e.g., transmitting a sensing beam and monitoring for a reflected signal from the passive object), creates a passive object UE context for the detected passive object, and stores the passive object UE context. As described above, the passive object UE context includes an identifier of the passive object and, optionally, one or more additional attributes of the passive object (e.g., shape, velocity, angle, etc.). Note that the first base station 800-1 preferably continues to monitor the passive object via sensing and updates the passive object UE context based on the monitoring (e.g., updates the one or more attributes of the passive object such as, e.g., geographic area/location, speed and direction of movement, and/or the like).
Step 804: While the first base station 800-1 continues to monitor the passive object (via sensing), the first base station 800-2 detects that a trigger condition for handover of the passive object UE context to one or more neighboring base stations (e.g., the second base station 800-2 and/or the third base station 800-3, in the illustrated example). The trigger condition may be based on one or more criteria such as, e.g., a location of the passive object, a direction of movement of the passive object (e.g., as expressed by its velocity vector), a speed of movement of the passive object (e.g., as expressed by its velocity vector), or the like, e.g., as compared to known boundaries of a respective geographic area served by the base station 800-1. In one embodiment, the first base station 800-1 detects that the trigger condition for handover of the passive object UE context has occurred by evaluating criteria that jointly determines that there is a possibility of an upcoming handover (step 804A). In addition, the first base station 800-1 determines, in one embodiment, a probability of upcoming handover for each of one or more neighboring base stations (e.g., the second base station 800-2 and the third base station 800-3) (step 804B). The probability of handover may be based on any suitable criteria such as, e.g., the direction of movement of the passive object relative to the geographic area served by the respective neighboring base station. Note that other parameters may be considered when determining the probability of handover.
Step 806: In this illustrated example, the first base station 800-1 sends the passive object UE context to the second base station 800-2, e.g., in response to step 804. In one embodiment, in step 804B, the first base station 800-1 determines that the determined probability of handover to the second base station 800-2 exceeds a predefined or configured threshold and, in response thereto, sends the passive object UE context to the second base station 800-2 in step 806. In another embodiment, the first base station 800-1 determines that the determined probability of handover to the second base station 800-2 is the highest among the determined probabilities of handover to a set of neighboring base stations (e.g., all neighboring base stations for which the probability of handover is greater than a predefined or configured threshold or for which there is a determined possibility of handover), and, in response thereto, sends the passive object UE context to the second base station 800-2.
Step 808: Optionally, the first base station 800-1 also sends the passive UE context to one or more additional neighboring base stations, which in this example include the third base station 800-3. For example, once the probabilities of handover are determined for the set of neighboring base stations in step 804B, the first base station 800-1 may send the passive object UE context to the set of neighboring base stations in descending order of probability of handover, e.g., until the passive object UE context has been sent to a predefined or configured maximum number of neighboring base stations or until there are either no more neighboring base stations in the set or the determined probability of handover falls below a predefined or configured minimum threshold for sending the passive object UE context.
Step 810: The second base station 800-2 receives the passive object UE context and, based thereon, enables a sensing beam in the direction of the passive object (e.g., as indicated by, e.g., a location of the passive object in the passive object UE context) and monitors for movement of the passive object (e.g., by monitoring for reflected signals from the passive object). Note that the second base station 800-2 preferably continues to update the passive object UE context (e.g., the attributes of the passive object comprised in the passive object UE context) based on results of the monitoring.
Step 812: Optionally, the second base station 800-2 disables the sensing beam if the passive object is not detected during certain time period. This time period may be predefined, configured, or based upon its own estimation (e.g., using information from the passive object UE context) or based upon indication received from the first base station 800-1.
Step 814: Optionally, the second base station 800-2 may perform one or more further actions based on the received passive object UE context and/or information obtained while monitoring the movement of the passive object after the handover. Such actions may include, e.g., notifying one or more devices of the presence of the passive object, the location of the passive object, the velocity of the passive object, and/or the like. As one specific example, the second base station 800-2 may alert a connected vehicle of a possible hazard/accident due to the passive object.
Steps 816, 818, and 820: The third base station 800-3 may perform steps corresponding to steps 810, 812, and 814 described above.

Note that the area (e.g., as expressed as an Area ID) can be defined in geographical coordinates, or in three-dimensional space.

It is also possible that sensing configuration is performed by a central entity such as sensing management function (SeMF) which can reside in location management function (LMF) or a module/node interacting with LMF. In such case, it is possible that once the passive object is sensed/detected by a base station (e.g., gNB), the base station may report such detection along with area ID and characteristics to the central entity (e.g., SeMF) which may assign an ID to the passive object. In such deployment, instead of using the base-station-to-base-station interface (e.g., Xn interface for NR), a separate protocol between the central entity (e.g., SeMF) and the base station (e.g., gNB) can be used to transfer the UE context.

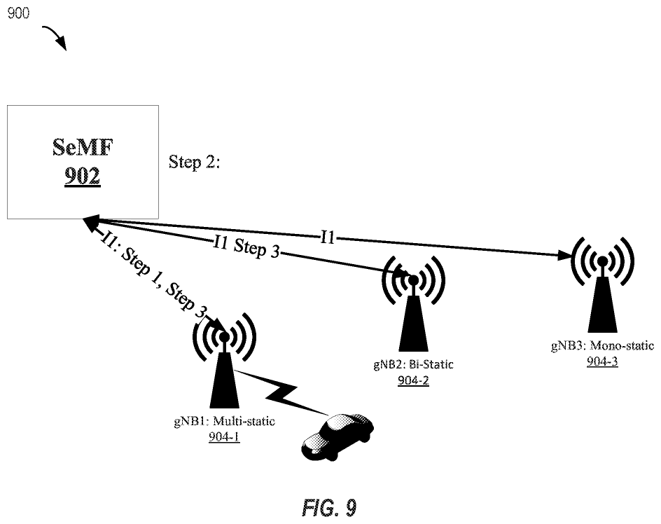

FIG. 9 illustrates one example of a system 900 in which a central entity is utilized in accordance with one embodiment of the present disclosure. In this example, the central entity is SeMF 902. The system 900 also includes base stations 904-1, 904-2, and 904-3 connected to SeMF 902 via respective interfaces. The operation of the system 900 of FIG. 9 is as follows:
Step 1: The base station 904-1 detects a passive object via sensing and provides information about the passive object to the SeMF 902. In one embodiment, the base station 904-1 is a gNB and the interface between the base station 904-1 and the SeMF is the I1 interface. I1 is interface defined between SeMF and gNB.
Step 2: The SeMF 902 assigns an Object ID to the passive object. The Object ID may be assigned to the passive object, e.g., in accordance with any of the embodiments described above. Alternatively, the SeMF 902 may assign the Object ID to the passive object in some other desired manner.
Step 3: SeMF informs one or more base stations (e.g., the base stations 904-1, 904-2, and 904-3) of the Object ID of the passive object. The SeMF 902 may inform the other base stations 904-2 and/or 904-3 of the Object ID of the passive object in relation to a handover event or mobility event in which the passive object moves towards or into the cell(s) served by these other base station(s) 904-2 and/or 904-3.

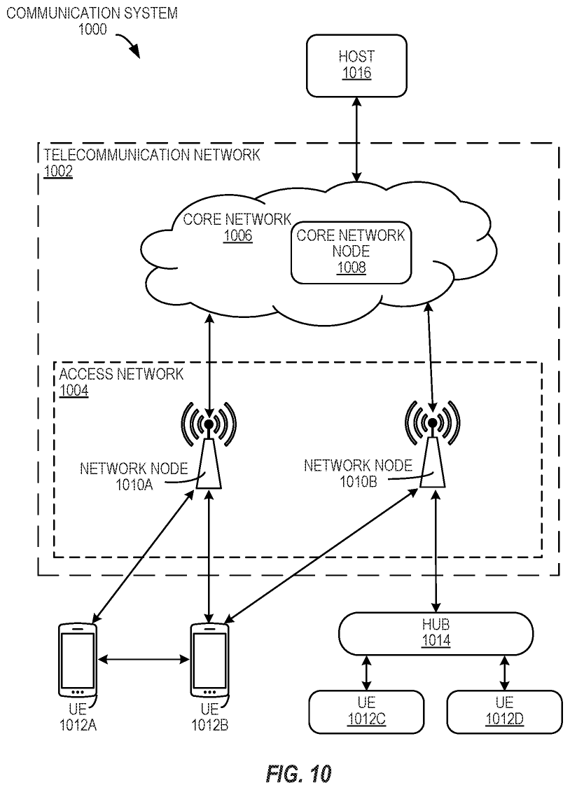

FIG. 10 shows an example of a communication system 1000 in accordance with some embodiments.

In the example, the communication system 1000 includes a telecommunication network 1002 that includes an access network 1004, such as a Radio Access Network (RAN), and a core network 1006, which includes one or more core network nodes 1008. The access network 1004 includes one or more access network nodes, such as network nodes 1010A and 1010B (one or more of which may be generally referred to as network nodes 1010), or any other similar Third Generation Partnership Project (3GPP) access node or non-3GPP Access Point (AP). The network nodes 1010 facilitate direct or indirect connection of User Equipment (UE), such as by connecting UEs 1012A, 1012B, 1012C, and 1012D (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system 1000 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1002 is a cellular network that implements 3GPP standardized features. Accordingly, the telecommunication network 1002 may support network slicing to provide different logical networks to different devices that are connected to the telecommunication network 1002. For example, the telecommunication network 1002 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single-or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 1014 communicates with the access network 1004 to facilitate indirect communication between one or more UEs (e.g., UE 1012C and/or 1012D) and network nodes (e.g., network node 1010B). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a Virtual Reality (VR) headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010B. The hub 1014 may also allow for a different communication scheme and/or schedule between the hub 1014 and UEs (e.g., UE 1012C and/or 1012D), and between the hub 1014 and the core network 1006. In other examples, the hub 1014 is connected to the core network 1006 and/or one or more UEs via a wired connection. Moreover, the hub 1014 may be configured to connect to a Machine-to-Machine (M2M) service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub-that is, a hub whose primary function is to route communications to/from the UEs from/to the network node 1010B. In other embodiments, the hub 1014 may be a non-dedicated hub-that is, a device which is capable of operating to route communications between the UEs and the network node 1010B, but which is additionally capable of operating as a communication start and/or end point for certain data channels.

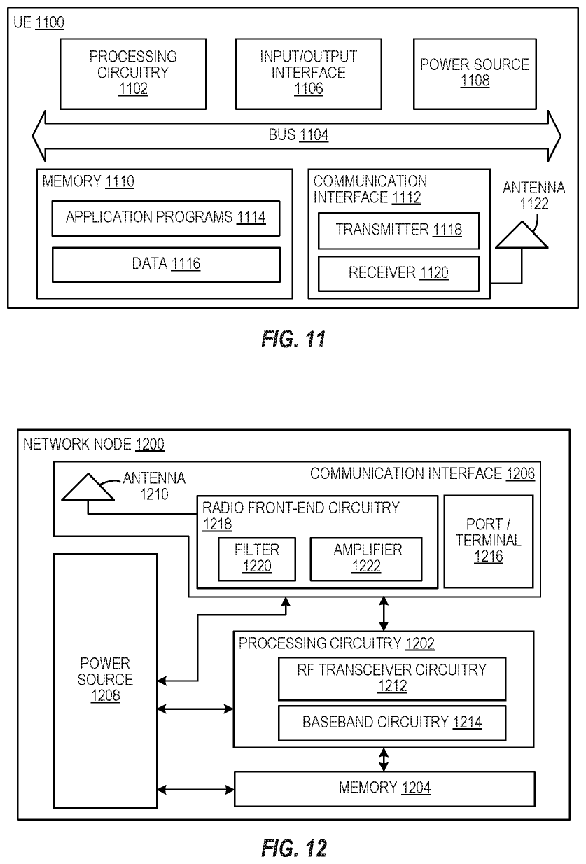

FIG. 11 shows a UE 1100 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1102 may include multiple Central Processing Units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging the power source 1108. Power circuitry may perform any formatting, converting, or other modification to the power from the power source 1108 to make the power suitable for the respective components of the UE 1100 to which power is supplied.

The memory 1110 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1110 may allow the UE 1100 to access instructions, application programs, and the like stored on transitory or non-transitory memory media, to off-load data, or to upload data. An article of manufacture, such as one utilizing a communication system, may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., the antenna 1122) and may share circuit components, software, or firmware, or alternatively be implemented separately.

In the illustrated embodiment, communication functions of the communication interface 1112 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1112, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements and transmits the results of such monitoring and/or measurements to another UE and/or a network node. The UE may in this case be an M 2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 12 shows a network node 1200 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes processing circuitry 1202, memory 1204, a communication interface 1206, and a power source 1208. The network node 1200 may be composed of multiple physically separate components (e.g., a Node B component and an RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1200 may be configured to support multiple RATs. In such embodiments, some components may be duplicated (e.g., separate memory 1204 for different RATs) and some components may be reused (e.g., an antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1200.

The processing circuitry 1202 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1200 components, such as the memory 1204, to provide network node 1200 functionality.

In some embodiments, the processing circuitry 1202 includes a System on a Chip (SOC). In some embodiments, the processing circuitry 1202 includes one or more of Radio Frequency (RF) transceiver circuitry 1212 and baseband processing circuitry 1214. In some embodiments, the RF transceiver circuitry 1212 and the baseband processing circuitry 1214 may be on separate chips (or sets of chips), boards, or units, such as radio units and digital units. In alternative embodiments, part or all of the RF transceiver circuitry 1212 and the baseband processing circuitry 1214 may be on the same chip or set of chips, boards, or units.

The memory 1204 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and the memory 1204 are integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. The radio front-end circuitry 1218 comprises filters 1220 and amplifiers 1222. The radio front-end circuitry 1218 may be connected to the antenna 1210 and the processing circuitry 1202. The radio front-end circuitry 1218 may be configured to condition signals communicated between the antenna 1210 and the processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of the filters 1220 and/or the amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface 1206 may comprise different components and/or different combinations of components.

In certain alternative embodiments, the network node 1200 does not include separate radio front-end circuitry 1218; instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes the one or more ports or terminals 1216, the radio front-end circuitry 1218, and the RF transceiver circuitry 1212 as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, the communication interface 1206, and/or the processing circuitry 1202 may be configured to perform any receiving operations and/or certain obtaining operations described herein as being performed by the network node 1200. Any information, data, and/or signals may be received from a UE, another network node, and/or any other network equipment. Similarly, the antenna 1210, the communication interface 1206, and/or the processing circuitry 1202 may be configured to perform any transmitting operations described herein as being performed by the network node 1200. Any information, data, and/or signals may be transmitted to a UE, another network node, and/or any other network equipment.

The power source 1208 provides power to the various components of the network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid or an electricity outlet) via input circuitry or an interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

Although the computing devices described herein (e.g., UEs, network nodes) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some example embodiments of the present disclosure are as follows:

Embodiment 1: A method performed by a first network node, the method comprising: detecting (802) a passive object via sensing; creating (802) a passive object context for the passive object, the passive object context comprising an identifier assigned to the passive object and information indicative of one or more attributes of the passive object; and storing (802) the passive object context for the passive object.

Embodiment 2: The method of embodiment 1 wherein the network node is a RAN node (800-1) or a core network node such as Sensing Management Function.

Embodiment 3: The method of embodiment 1 or 2 wherein the identifier assigned to the passive object comprises a combination of:
a first identifier of the first network node (800-1), a cell operated by the first network node (800-1) in which the passive object is located, and/or a beam provide by the first network node (800-1) in which the passive object is located; and
a second identifier for the passive object.

Embodiment 4: The method of embodiment 3 wherein the second identifier is specific to the passive object.

Embodiment 5: The method of embodiment 3 wherein the second identifier is based on a geographic location of the passive object.

Embodiment 6: The method of embodiment 3 wherein the second identifier is based on a combination of a velocity of the passive object and a geographic location of the passive object.

Embodiment 7: The method of embodiment 5 or 6 wherein the geographic location of the passive object is a grid location of the passive device within a predefined geographic grid.

Embodiment 8: The method of embodiment 1 or 2 wherein the identifier assigned to the passive object is: specific to the passive object; based on a geographic location of the passive object; or based on a combination of a velocity of the passive object and a geographic location of the passive object.

Embodiment 9: The method of embodiment 1 or 2 wherein the identifier assigned to the passive object comprises: a first set of bits indicative of the network node (800-1), a cell operated by the network node (800-1), or a beam served by the first network node (800-1); a second set of bits indicative of a location of the passive object; and a third set of bits indicative of the passive object.

Embodiment 10: The method of any of embodiments 1 to 9 wherein the one or more attributes of the passive object indicated by the information comprised in the passive object context comprise:
(a) a current cell operated by the first network node (800-1) in which the passive object is located;
(b) a current beam provided by the first network node (800-1) in which the passive object is located;
(c) a round trip time of a reflected signal from the passive object;
(d) a Doppler frequency of a reflected signal from the passive object;
(e) a velocity of the passive object;
(f) a speed of the passive object;
(g) a direction of movement of the passive object;
(h) an angle of movement of the passive object relative to the first network node (800-1);
(i) a shape of the passive object;
(j) a location of the passive object (e.g., a grid location within a geographic grid);
(k) passive object type;
(l) probability of the passive object moving to a geographic area or cell served by a neighboring network node;
(m) priority; or
(n) a combination of any two or more of (a)-(m).

Embodiment 11: The method of any of embodiments 1 to 10 wherein the passive object context further comprises a timestamp.

Embodiment 12: The method of any of embodiments 1 to 11 further comprising: detecting (804) a trigger condition for handover of the passive object context to one or more neighboring network nodes (800-2, 800-3); and. responsive to detecting (804) the trigger condition for handover of the passive object context, sending (806, 808) the passive object context of the passive object to at least one of the one or more neighboring network nodes (800-2, 800-3).

Embodiment 13: A method performed by a second network node (800-2), the method comprising: receiving (806), from a first network node (800-1), a passive object context for a passive object, the passive object context comprising an identifier assigned to the passive object and information indicative of one or more attributes of the passive object; and enabling (810) a sensing beam in a direction of the passive object.

Embodiment 14: The method of embodiment 13 wherein the first network node (800-1) is a Radio Access Network, RAN, node (800-1) or a first core network node and the second network node (800-2) is a RAN node.

Embodiment 15: The method of embodiment 13 or 14 wherein the direction of the passive object is determined based on information comprised in the passive object context or information received from the first network node (800-1).

Embodiment 16: The method of any of embodiments 13 to 15 further comprising monitoring (810) the passive object based on the sensing beam and updating (812) the passive object context of the passive object based on one or more results of the monitoring (810).

Embodiment 17: The method of any of embodiments 13 to 15 further comprising determining (812) that the passive object has not been detected, based on the sensing beam, for a certain amount of time and, responsive thereto, disabling (812) the sensing beam.

Embodiment 18: The method of embodiment 17 wherein the certain amount of time is predefined, configured, or determined by the second network node (800-2) (e.g., based on information comprised in the passive object context).

Embodiment 19: The method of any of embodiments 13 to 18 wherein the identifier assigned to the passive object comprises a combination of:
a first identifier of the first network node (800-1), a cell operated by the first network node (800-1) in which the passive object is located, and/or a beam provide by the first network node (800-1) in which the passive object is located; and
a second identifier for the passive object.

Embodiment 20: The method of embodiment 19 wherein the second identifier is specific to the passive object.

Embodiment 21: The method of embodiment 19 wherein the second identifier is based on a geographic location of the passive object.

Embodiment 22: The method of embodiment 19 wherein the second identifier is based on a combination of a velocity of the passive object and a geographic location of the passive object.

Embodiment 23: The method of embodiment 21 or 22 wherein the geographic location of the passive object is a grid location of the passive device within a predefined geographic grid.

Embodiment 24: The method of any of embodiments 13 to 18 wherein the identifier assigned to the passive object is: specific to the passive object; based on a geographic location of the passive object; or based on a combination of a velocity of the passive object and a geographic location of the passive object.

Embodiment 25: The method of any of embodiments 13 to 18 wherein the identifier assigned to the passive object comprises: a first set of bits indicative of the first network node (800-1), a cell operated by the first network node (800-1), or a beam served by the first network node (800-1); a second set of bits indicative of a location of the passive object; and a third set of bits indicative of the passive object.

Embodiment 26: The method of any of embodiments 13 to 25 wherein the one or more attributes of the passive object indicated by the information comprised in the passive object context comprise:
(a) a current cell operated by the first network node (800-1) in which the passive object is located;
(b) a current beam provided by the first network node (800-1) in which the passive object is located;
(c) a round trip time of a reflected signal from the passive object;
(d) a Doppler frequency of a reflected signal from the passive object;
(e) a velocity of the passive object;
(f) a speed of the passive object;
(g) a direction of movement of the passive object;
(h) an angle of movement of the passive object relative to the first network node (800-1);
(i) a shape of the passive object;
(j) a location of the passive object (e.g., a grid location within a geographic grid);
(k) passive object type;
(l) probability of the passive object moving to a geographic area or cell served by a neighboring network node;
(m) priority; or
(n) a combination of any two or more of (a)-(m).

Embodiment 27: The method of any of embodiments 13 to 26 wherein the passive object context further comprises a timestamp.

Embodiment 28: A method performed by a radio access network, RAN, node (904-1), the method comprising: detecting (FIG. 9, step 1) a passive object via sensing; sending (FIG. 9, step 1), to a central entity (902), information about the passive object; and receiving (FIG. 9, step 3), from the central entity (902), an identifier assigned to the passive object.

Embodiment 29: A method performed by a radio access network, RAN, node (904-2), the method comprising: receiving (FIG. 9, step 3), from a central entity (902), an identifier assigned to a passive object; and storing (FIG. 9, step 3) the identifier assigned to the passive object.

Embodiment 30: The method of embodiment 29 wherein receiving the identifier comprises receiving the identifier assigned to the passive object in association with a mobility event in which the passive object moves into or moves towards a geographic area served by the RAN node (904-2).

Embodiment 31: A network node comprising: processing circuitry configured to perform any of the steps of any of embodiments 1-30; and power supply circuitry configured to supply power to the processing circuitry.

Those skilled in the art will recognize improvements and modifications to the embodiments of the present disclosure. All such improvements and modifications are considered within the scope of the concepts disclosed herein.

### REFERENCES

1. 3GPP S2-2106022 New SID: 5G Architecture Enhancements for Harmonized Communications and Sensing Services, August 2021.
2. C. B. Barneto et al., “High-accuracy radio sensing in 5G new radio networks: Prospects and self-interference challenge,” in Proc. 53^{rd} Asilomar Conf. Signals Syst. Comput., Pacific Grove, CA, USA, Nov. 2019, pp. 1159-1163
3. C. B. Barneto et al., “Full-duplex OFDM radar with LTE and 5G NR waveforms: Challenges, solutions, and measurements,” IEEE Trans. Microw. Theory Techn., vol. 67, no. 10, pp. 4042-4054, Oct. 2019.
4. O. Kanhere, S. Goyal, M. Beluri and T. S. Rappaport, “Target Localization using Bistatic and Multistatic Radar with 5G NR Waveform,” 2021 IEEE 93rd Vehicular Technology Conference (VTC2021-Spring), 2021, pp. 1-7, doi: 10.1109/VTC2021-Spring51267.2021.9449071.

1. A method performed by a first network node of a wireless communication network, the method comprising:
detecting a passive object via sensing;
creating a passive object context for the passive object, the passive object context comprising an identifier assigned to the passive object and information indicative of one or more attributes of the passive object; and
storing the passive object context for the passive object.

2. The method of claim 1 wherein the network node is a Radio Access Network, RAN, node of a cellular communications system.

3. The method of claim 1 wherein the network node is a core network node of a cellular communications system.

4. The method of claim 1 wherein the identifier assigned to the passive object comprises a combination of:
a first identifier of any one or more of the following: the first network node, a cell operated by the first network node in which the passive object is located, and a beam provide by the first network node in which the passive object is located; and
a second identifier for the passive object.

5. The method of claim 4 wherein the second identifier is specific to the passive object.

6. The method of claim 4 wherein the second identifier is based on a geographic location of the passive object.

7. The method of claim 4 wherein the second identifier is based on a combination of a velocity of the passive object and a geographic location of the passive object.

8. The method of claim 6 wherein the geographic location of the passive object is a grid location of the passive device within a predefined geographic grid.

9. The method of claim 1 wherein the identifier assigned to the passive object is:
specific to the passive object;
based on a geographic location of the passive object; or
based on a combination of a velocity of the passive object and a geographic location of the passive object.

10. The method of claim 1 wherein the identifier assigned to the passive object comprises:
a first set of bits indicative of the network node, a cell operated by the network node, or a beam served by the first network node;
a second set of bits indicative of a location of the passive object; and
a third set of bits indicative of the passive object.

11. The method of claim 1 wherein the one or more attributes of the passive object indicated by the information comprised in the passive object context comprise:
(a) a current cell operated by the first network node in which the passive object is located;
(b) a current beam provided by the first network node in which the passive object is located;
(c) a round trip time of a reflected signal from the passive object;
(d) a Doppler frequency of a reflected signal from the passive object;
(e) a velocity of the passive object;
(f) a speed of the passive object;
(g) a direction of movement of the passive object;
(h) an angle of movement of the passive object relative to the first network node
(i) a shape of the passive object;
(j) a location of the passive object;
(k) passive object type;

(l) probability of the passive object moving to a geographic area or cell served by a neighboring network node;
(m) priority; or
(n) a combination of any two or more of (a)-(m).

12. The method of claim 1 wherein the passive object context further comprises a timestamp.

13. The method of claim 1 further comprising:
detecting a trigger condition for handover of the passive object context to one or more neighboring network nodes; and
responsive to detecting the trigger condition for handover of the passive object context, sending the passive object context of the passive object to at least one of the one or more neighboring network nodes.

14. The method of claim 13 wherein the trigger condition for handover of the passive object context to one or more neighboring network nodes is based on any one or more of the following: a location of the passive object, a direction of movement of the passive object, and a speed of movement of the passive object.

15. The method of claim 13 wherein detecting the triggering condition for handover of the passive object context to the one or more neighboring nodes comprises determining a probability of the passive object moving to a geographic area or cell served by a neighboring network node.

16. The method of claim 13, wherein the triggering condition is a condition where the determined probability is greater than a threshold probability.

17. (canceled)

18. (canceled)

19. A first network node for a wireless communication network, the first network node comprising:
a communication interface; and
processing circuitry associated with the communication interface, the processing circuitry configured to cause the first network node to:
detect a passive object via sensing;
create a passive object context for the passive object, the passive object context comprising an identifier assigned to the passive object and information indicative of one or more attributes of the passive object; and
store the passive object context for the passive object.

20. (canceled)

21. A method performed by a second network node of a wireless communication network, the method comprising:
receiving, from a first network node, a passive object context for a passive object, the passive object context comprising an identifier assigned to the passive object and information indicative of one or more attributes of the passive object; and
enabling a sensing beam in a direction of the passive object.

22. The method of claim 21 wherein the first network node is a Radio Access Network, RAN, node of a cellular communications system or a first core network node of the cellular communications system.

23-38. (canceled)

39. A second network node for a wireless communication network, the second network node comprising:
a communication interface and
processing circuitry associated with the communication interface, the processing circuitry configured to cause the second network node to:
receive, from a first network node, a passive object context for a passive object, the passive object context comprising an identifier assigned to the passive object and information indicative of one or more attributes of the passive object; and
enable a sensing beam in a direction of the passive object.

40-47. (canceled)
